(19) United States
(12) Patent Application Publication
(10) Pub. No.: US 2006/0239700 A1
(43) Pub. Date: Oct. 26, 2006

(54) Accordion jam detection of printed media

(75) Inventors: Kevin Dean Schoedinger, Lexington, KY (US); Richard Winston Thomas, Nicholasville, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc

(21) Appl. No.: 11/112,804

(22) Filed: Apr. 22, 2005

(51) Int. Cl. G03G 15/00

(52) U.S. Cl. 399/21

(57) ABSTRACT

An apparatus, system and method of detecting paper jams in printer, such as in the fuser assembly of an electrophotographic device. A plurality of sensors may detect the leading edge of the sheet of paper as it exits the fuser hot roll nip. The sensors may include a media exit sensor and a narrow media sensor.

### FIELD OF THE INVENTION

The present invention relates to an apparatus and method of detecting and/or responding to paper jams in a printing device.

### BACKGROUND OF THE INVENTION

An electrophotographic printer prints an image on media, such as sheets of paper, from toner contained in a toner cartridge. A developer roller or sleeve may be mounted within the toner cartridge in proximity to a photoconductive drum. The photoconductive drum may be charged, and a laser may scan the charged photoconductive drum with a laser beam to discharge the surface and form a latent image thereon. The developer roller may attract statically charged toner from the toner container. Toner may be transferred from the developer roller to the photoconductive drum to develop the latent image formed on the photoconductive drum. The developed image may then be transferred to statically charged sheets of media. The sheets may be fed through a heated fuser assembly, where the heat fixes the visible image.

The fusing station in desktop printers may normally be composed of a heated, fluoropolymer-coated aluminum fusing roll, a soft elastomeric pressure roll, and a means to apply pressure between the two rolls. The combined action of heat, pressure, and dwell time in the nip formed between the two rolls may cause the thermoplastic toner to soften and flow between the media fibers. Upon cooling, the toner may solidify and become firmly affixed to the media.

In conventional printers the adhesion of the toner (and subsequently the media) to the fusing roll during the fusing process may be alleviated by a media/roller separation mechanism that is in contact with the fusing roll. This separation mechanism may consist of spring loaded fingers (“detack fingers”) that may be in contact with the fusing roll. The contact detack fingers may accomplish their design intent of stripping media off of the fusing roll due to frictional contact with the fuser hot roll. A buildup of toner on the contact detack fingers may at times cause the detack fingers to have a very blunt tip and defeat the original design intent by allowing a sheet of media to become caught on the finger. The toner buildup may result in unnecessary fuser jams, or in toner being deposited onto the page after a threshold of toner has been accumulated on the detack tip followed by release.

Fuser life may often be a function of wear and even failure of the mechanical and electrical elements of the fuser assembly. Fuser life may also be affected by the frequency of paper jams which occur as the media feeds through the fuser assembly. Paper jams in an electrophotographic device may be the result of: (1) jams that can be cleared by the device user and (2) jams which cannot be cleared by the user and require a service call by a service technician to allow someone more familiar with the functioning of the device to dismantle the device and clear the jam. The second type of paper jam is more significant as (1) the user may try to remove the jam and, in doing so, damage the fuser assembly and (2) it may represent a significant downtime for the electrophotographic device. Often, the service call may result in a warranty replacement of the fuser assembly. In either case, the user may be dissatisfied with the performance of the device.

One type of paper jam which requires a service call for correction has been termed an “accordion” paper jam. In this instance, as paper may be conveyed through the fuser nip, one portion exits the nip but remains on the hot roll surface where it may be captured under one or more of the detack fingers. However, paper continues convey at other locations and a leading edge will emerge which may cover the exit sensor for the fuser assembly. The print engine then assumes that the operation is normal and continues to feed the media through the nip. The result then is that an entire length of printed media “fan folds” in an accordion-like manner as it is forced into the rear portion of the fuser assembly. This may create a paper jam which can only be removed by a service technician and not by the user.

### SUMMARY OF THE INVENTION

An exemplary embodiment of the present invention relates to a printer comprising a media fixing mechanism that may fix images on sheets of media; a media position sensor that may be capable of identifying and signaling whether media is exiting or not exiting said media fixing mechanism at different locations, and a controller that may be capable of adjusting feeding of the media through the media fixing mechanism wherein the controller is in communication with the sensor.

Another exemplary embodiment of the present invention relates to a method of detecting a media jam in a media fixing mechanism for fixing images on sheets of media comprising supplying a printer that may be capable of feeding media to a media fixing mechanism and wherein the media is capable of exiting the media fixing mechanism. The printer may also be capable of identifying whether fed media is exiting or not exiting the media fixing mechanism at different locations. The printer may also be capable of adjusting the feeding of media to the media fixing mechanism when one portion of media is exiting the media fixing mechanism at one location and one portion is not exiting the media fixing mechanism at another location.

Another exemplary embodiment of the present invention relates to a method of detecting a media jam in a media fixing mechanism for fixing images on sheets of media comprising supplying a printer that is capable of feeding media to a media fixing mechanism and wherein the media is capable of exiting the media fixing mechanism. The printer may also be capable of sensing a media size dimension and identifying whether fed media is exiting or not exiting the media fixing mechanism at different locations. The printer may also be capable of either adjusting the feeding of media to the media fixing mechanism when one portion of media is exiting the media fixing mechanism at one location and one portion is not exiting the media fixing mechanism at another location or feeding the media and not adjusting the feeding of media.

Another exemplary embodiment of the present invention relates to a printer comprising a fuser assembly comprising a heated component and a transport component forming a nip having an entry region and exit region for conveying media. The fuser assembly may also have one or a plurality of detack components located adjacent the exit region of the nip and a sensor disposed adjacent the exit region of the nip capable of identifying and signaling whether media is exiting or not exiting the exit region. The printer or fuser assembly may also have a controller capable of feeding the media through the nip wherein the controller is in communication with a plurality of sensors wherein the controller is capable of adjusting the feeding of media to the media fixing mechanism.

### BRIEF DESCRIPTION OF THE DRAWINGS

The attached drawings illustrate preferred embodiments of the invention in which;

FIG. 1 is a cut away, diagrammatic view of an electrophotographic printer.

FIG. 2 is a perspective view of a fuser assembly from the entry end, illustrating detack fingers.

FIG. 3 is a diagrammatic view of one side of the fuser assembly of FIG. 2.

FIG. 4 is illustrative of a belt fuser.

FIG. 5 is a diagrammatic plan view of a fuser roller of the printer of FIG. 1.

FIG. 6 illustrates the initiation of a paper jam in a view similar to FIG. 5 with the leading edge of the media caught on one of the detack fingers.

FIG. 7 is a block diagram of the electrical circuitry of the printer of FIG. 1.

FIGS. 8 and 9 are flow diagrams of the operation of this invention.

FIG. 10 is an illustration of an embodiment of the present invention relating to an article of machine readable media in relation to a processor and a user interface.

### DETAILED DESCRIPTION OF THE INVENTION

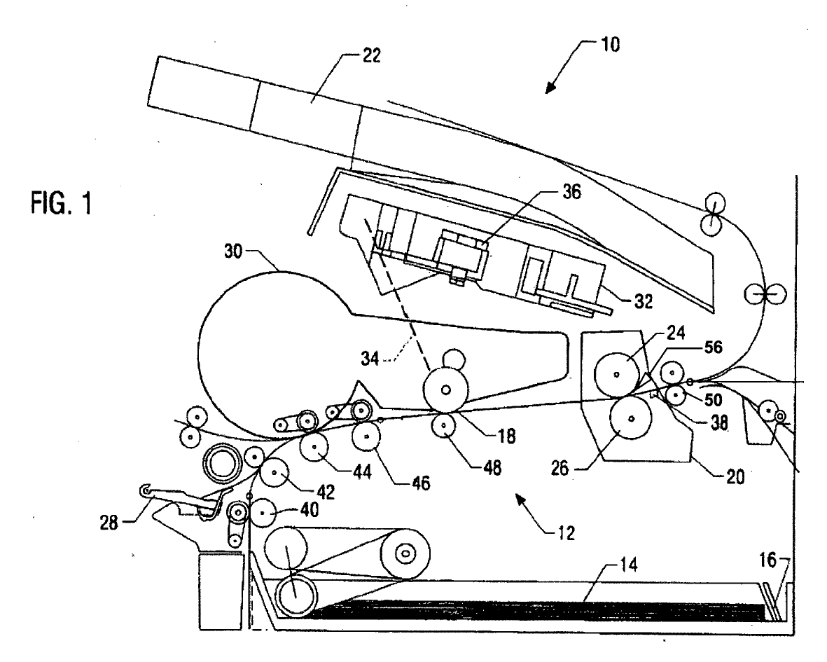

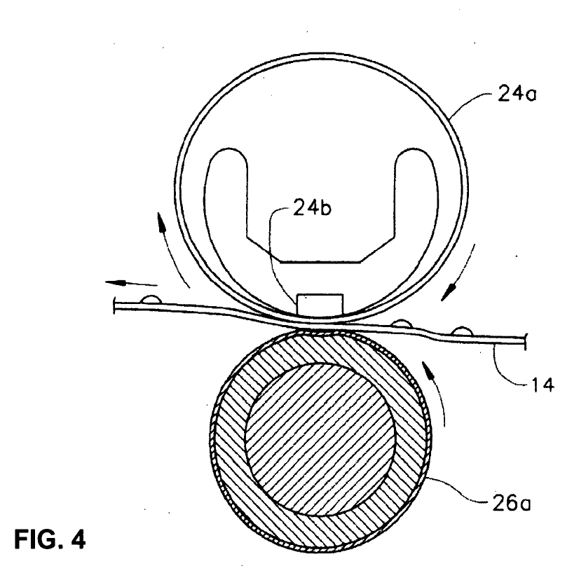

Referring to the drawings, and initially to FIG. 1 thereof, an electrophotographic printer 10 may include a media feed path 12 for feeding sheets of media 14 from a media tray 16 past a photoconductive drum 18 and a fuser assembly 20 to an output tray 22. It should be appreciated that media may be anything from paper, to film such as transparencies, cardstock, envelopes, labels, etc. The media fixing mechanism may therefore be a fuser assembly 20 which may include a nip roller fuser formed by a fuser roller 24, which may be heated to a relatively high temperature to fuse particles of toner to the sheets of media 14, and a backup roller 26. It will be appreciated that fuser assembly 20 may also be of the belt fuser type (See FIG. 4) in which a belt 24a may pass over a ceramic heater 24b with the media 14 in a nip between belt 24a and a backup roller 26a.

The photoconductive drum 18 may form an integral part of a replaceable toner cartridge 30 inserted in the printer 10. A printhead 32 may be disposed in the printer 10 for scanning the photoconductive drum 18 with a laser beam 34 to form a latent image thereon. The laser beam 34 may place a spot of light on a facet of a rotating polygonal mirror 36, which then may redirect the laser beam 34 so that it may ultimately sweep or “scan” across a “writing line” on the photoconductive drum 18, thereby creating, in a black and white laser printer, a raster line of either black or white print elements, also known as “pels.” The polygonal mirror 36 may typically have six or eight facets, and each one-sixth or one-eighth rotation of the polygonal mirror 36, respectively, may create an entire swept raster scan of laser light that ultimately may become a writing line on a sheet of media 14. The operation of the printhead 32 is more fully described in U.S. Pat. No. 5,877,798 to Clarke et al., also assigned to the assignee of the present application.

The printer 10 may have a narrow media sensor 38 located downstream, as viewed from the direction of flow of the media 14, from the photoconductive drum 18 and the fuser assembly 20. The narrow media sensor 38 may detect the presence of sheets of narrow media (envelopes, checks, etc.) in the media feed path 12. A plurality of rollers 40, 42, 44, 46, 48 may function in a known manner to transfer the sheets of media 14 from the media tray 16 or multi-purpose tray 28 through the media feed path 12.

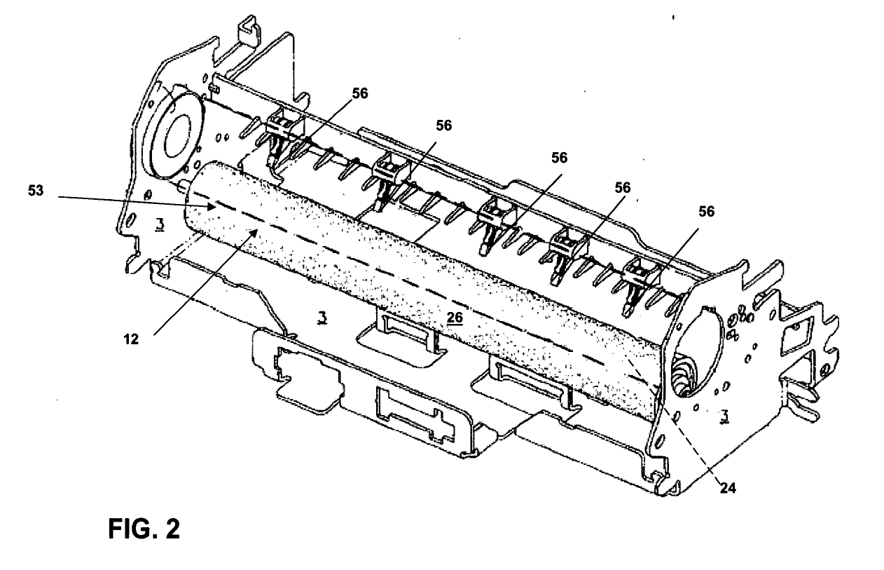

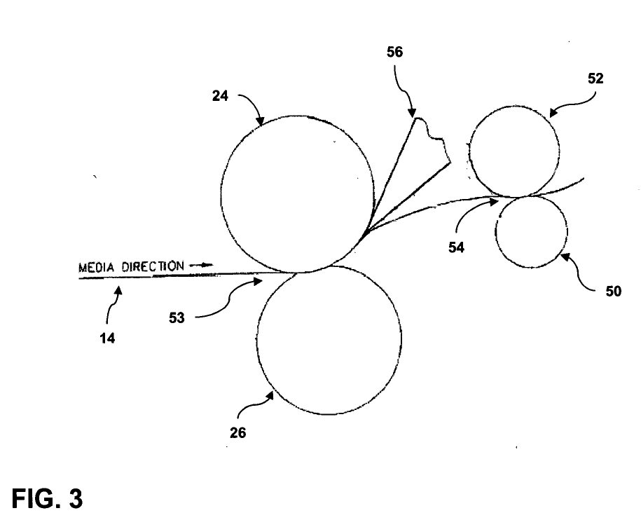

FIG. 2 is a perspective view of a portion of the fuser assembly of FIG. 1 from the entry end. A fuser hot roll 24 (in phantom) may be is mounted into a fuser frame 3 by use of bearings 7. The print media (not shown) may travel along a paper feed path 12 between a nip 53 between the fuser hot roll 24 and a pressure roll 26, and exits this nip through a second nip 54 between a first exit roller 52 and a second exit roller 50. (See FIG. 3.) Exit rollers 52 and 50 (FIG. 3) may be typically rotated at a somewhat greater linear velocity so as to produce a slight tension on the print media. This is also referred to as an “overdrive” configuration. As can be seen in FIG. 2 there may be a total of five (5) structural features termed detack fingers 56, although any number may be employed.

In FIG. 3, a side view of the fuser assembly, the print media may approach from an entrance location along the media path and may be directed through a nip 53 formed by the fuser hot roll 24 and the pressure roller 26. FIG. 3 shows an optional interference between these two rolls, and in actuality, the pressure roll 26 may be coated with a soft outer material for a thickness of approximately 5 mm which may deform while applying pressure against the media, and which may cause the media to be pressed against the fuser hot roll 24 at the nip 53. The media 14 may traverse through the nip 53 and may begin to exit the nip to an exit location in the media path as seen in FIG. 3. Under certain situations, a leading edge of the media may not readily separate from the fuser hot roll.

Accordingly detack fingers 56 may be supplied which may be used to engage with and ensure that the leading edge of the media actually separates from the fuser hot roll 24. To facilitate the result that the leading edge of the print media separates some small amount from the hot roll 24, it may be useful to avoid placement of toner over a certain distance from the leading edge of media. This distance is referred to as the “top margin” of the page. This may be a relatively small distance but it nevertheless may be considered to assist the detack fingers 56 in separating the print media from the fuser hot roll 24.

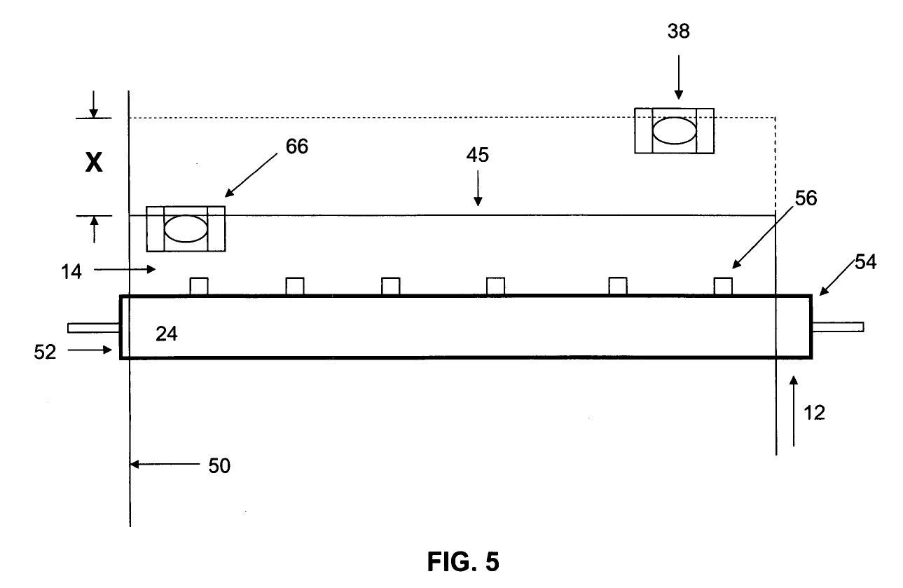

FIG. 5 illustrates the fuser roller 24 and a reference edge 50 of the media feed path 12. Sheets of narrow media (not shown) which would generally be located at 14 may be left justified and aligned with the reference edge 50 as they are fed through the media feed path 12. In one particular embodiment, the fuser roller 24 may be slightly wider than 8.5 inches, so that it may accommodate full-width media such as U.S. letter size paper and A4 paper. However, the fuser roll may be much longer or shorter for printing pages as large as, for example, “E” size paper, or as small as, for example, just a few inches. It should also be appreciated that the media may be center fed and would thus not necessarily be aligned to a reference edge.

A narrow media sensor 38 may be located along the width and between two edges 52 and 54 of the fuser roller 24. For example, the narrow media sensor may be positioned approximately 60-90% of the distance (proceeding left to right) from the edge 52 to edge 54. In any event, such as to accommodate center fed pages, the narrow media sensor 38 may be located at different positions across the width of the media feed path 12. An exit sensor 66 may be located at a location along the width of the roller that is different from the narrow media sensor 38 to similarly detect the presence of a sheet of media 14 as it leaves the fuser nip 53 (see FIG. 3). As illustrated, exit sensor 66 may be located at some other location (left-to-right) relative to the narrow media sensor 38. In addition, it can be seen that the narrow media sensor 38 and exit sensor 66 may also be positioned at different locations relative to fuser roller 24. However, it should be appreciated that the narrow media sensor 38 and exit sensor 66 may also be positioned at the same distance relative to the fuser roller 24.

As illustrated, sensor 66 and sensor 38 may be spaced from one another a selected distance “X”. In an exemplary embodiment, such distance may be about 20-40 mm, including all increments and values therebetween. Accordingly, at, e.g., a spacing of about 30 mm, there is a balance achieved wherein the sensors detect an accordion jam, while ensuring that a sufficient amount of paper remains available to the user on the feed side of the fuser, so that the paper may be pulled back and out of the fuser nip.

With attention still directed at FIG. 5, the media 14 may exit the nip 53 between the fuser hot roll 24 and backup roll 26 (see again FIG. 3) and clear the detack fingers 56. In this view the leading edge 45 of the media 14 is moving in the direction of the arrow for the media path 12 and may encounter sensor 66 as well as sensor 38. These two sensors 66 and 38 may perform separate and distinct functions to (1) detect that the media has exited the fuser hot roll nip and (2) that normal width media is being processed.

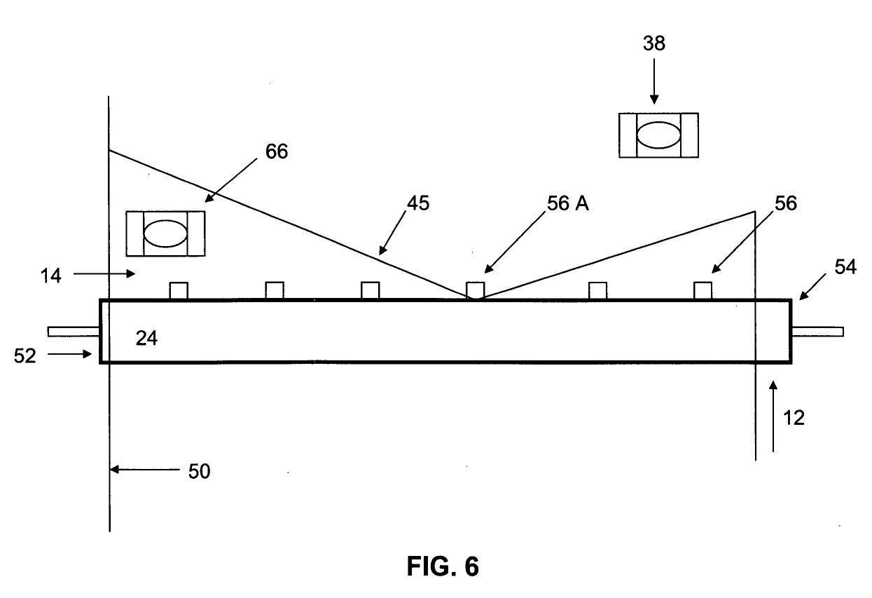

FIG. 6 illustrates in diagrammatic view certain features of an accordion-type paper jam. As illustrated, the leading edge 45 of the sheet of media 14 encountered the detack fingers 56 but has become captured or snagged on one of the fingers, 56A. The leading edge of the paper 45 on the left side (or reference edge 50) of the fuser hot roll 24 has covered the exit sensor 66, but on the right side of the leading edge the leading edge of the media has not reached the narrow media sensor 38. In this situation, with a conventional printer, the print engine will continue to advance the media 14 toward the back of the fuser assembly but not through exit rollers 50 and 52 (see FIG. 3). The result is that the sheet of media 14 will continue to be conveyed through the fuser nip. Since the leading edge 45 does not pass between the exit rolls 50, 52, the sheet of media 14 will create a jam in the fuser assembly as it folds up “accordion style.” Generally, this type of jam may not be accessible for clearing by the user and may result in a service call and warranty replacement.

In accordance with one exemplary operational description of the present invention, when the sensor 38 in combination with sensor 66 present a condition that only one of these sensors detects the media 14, a signal may be generated for the print engine to stop feeding media through the fuser nip. In one embodiment, the stop signal may be issued based on time intervals or information, such as the case where a desired time interval between the sensors 38 and 66 has not been met. Furthermore, positional information or intervals may be detected, which when not satisfied, may trigger the signal to stop the print engine from feeding media through the fuser nip.

In this manner at least a portion of the sheet of media 14 may remain in front of the fuser nip 53 (the entire sheet not being sent through) such that the portion may be accessible for the user of the device to grasp and ultimately remove the entire sheet, clearing the jam. It should be understood that more than two sensors may be employed. For example, three or more sensors are contemplated to accommodate media of various sizes. In addition, the invention herein contemplates the use of a single sensor device that may sense media presence at different locations.

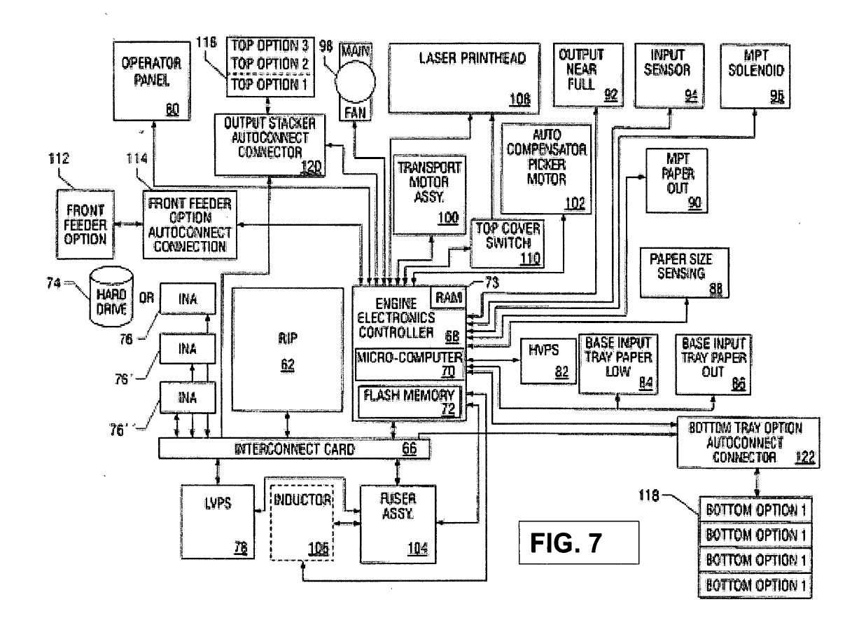

FIG. 7 provides a block diagram of the electrical circuitry of an exemplary printer in accordance with the present invention. A raster image processor (RIP) 62 may send the bitmap through an interconnect card 66 to an engine controller 68. The engine controller 68 may act as a controller and data-manipulating device for the various hardware components within the print engine 64. The engine controller 68 may include a programmed microcomputer 70, a flash memory 72 and a random access memory (RAM) 73, for storing programs to be run thereon. In an exemplary embodiment, the programmed microcomputer 70 may be a Toshiba TMP90CM38 microcontroller. Other devices, such as a hard drive 74, may be connected to the RIP 62 via one of the integrated network adapters 76, 76′, 76″ and the interconnect card 66. A low voltage power supply (LVPS) 78 may supply the engine controller 68 and the RIP 62 with power via the interconnect card 66.

The engine controller 68 may be connected to an operator panel 80, which is an input/output interface providing a user with a method to supply the printer 10 with configuration information. In one embodiment, the operator panel 80 may be a LCD panel and input buttons. A user may use the operator panel 80 to supply the printer 10 with media information. The operator panel 80 may also display any of a large number of messages to the user, including status messages, e.g. ready/busy, output tray empty, output tray near full, output tray full, and error messages. The engine controller 68 may be connected to a high voltage power supply (HVPS) 82, which supplies high voltages to hardware components, such as the photoconductive drum 18. A base input tray paper LED indicating a low paper condition 84, a base input tray paper LED indicating a no paper condition 86, a paper size sensor 88, a multifunction paper tray LED indicating a no paper condition 90, an output tray LED 92 indicating a near full output tray condition, an input sensor LED 94, which indicates that a sheet of media 14 is about to be printed, and a multipurpose tray (MPT) solenoid 96, which picks the sheets of media 14 out of the multipurpose tray 28, may be connected to the engine controller 68. Additional components operated under control of the engine controller 68 may include a main fan 98, a transport motor assembly 100, and an autocompensator picker motor 102. A fuser assembly 104, generally corresponding to the fuser assemblies noted above, may operate under control of the engine controller 68. A fuser on/off signal may pass from the engine controller 68 through the interconnect card 66 to the low voltage power supply (LVPS) 78. There, the on/off signal may actuate a triac (not shown), thereby allowing AC current to flow into the fuser lamp or heater inside the fuser assembly 104 (depending on the type of fuser 104 employed in the printer 10). An inductor 106 may be connected to the fuser assembly 104 and the engine controller 68. A laser printhead 108 may be connected to the engine controller 68 and a top cover switch 110, which may also connected to the engine controller 68.

A front feeder option 112 may be connected to the engine controller 68 through a front feeder option autoconnect connector 114. Envelopes may be fed from the multi-purpose tray or from a separate tray associated with the front feeder option 112. The printer 10 has an optional output tray 116 and an optional input tray 118 with different options that may be configurable under the control of a software program stored in the engine controller 68. The output and input trays 116, 118 may be connected by an output stacker autoconnect connector 120 and a bottom tray option autoconnect connector 122, respectively, which may provide electrical connections to the engine controller 68.

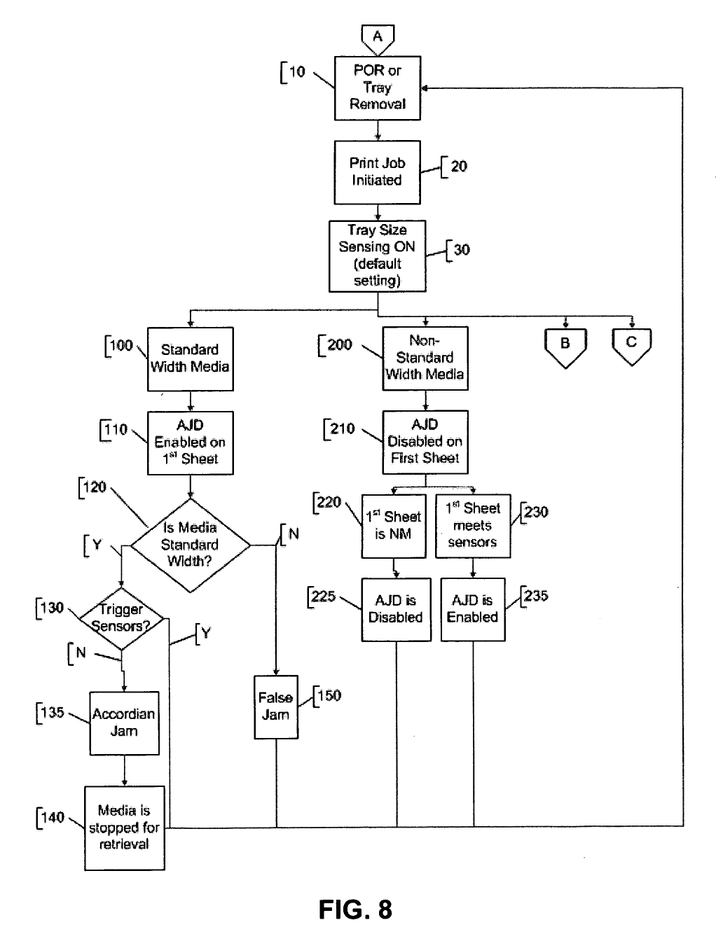

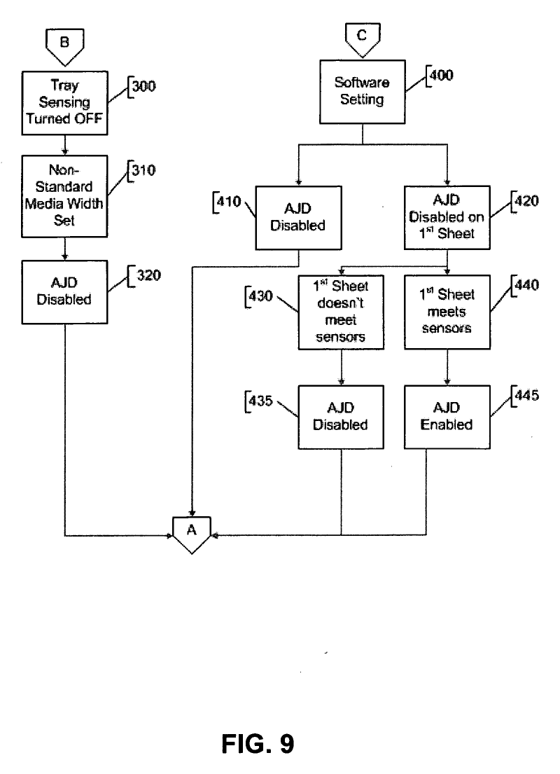

To facilitate any or all of the above, other aspects of the printer may be modified, including the use of software and subroutines to assist in overall operation. For example, the printer may be configured such that it may include tray size sensing to determine the size of the media being fed. In the event that the size (width) of the media is unknown, the printer may use the first sheet through the fuser to determine if the media is wide or narrow. FIGS. 8 and 9 describe an exemplary operation of accordion jam detection (AJD). At Block 10 the power on signal, tray removal signal, or another reset type signal may be sensed. Then a print job may be initiated at Block 20. Tray size sensing may be set on as a default setting, illustrated by Block 30.

The media width may be sensed as either standard width media, at Block 100, or non-standard width media, at Block 200. When standard width media is sensed, which may be understood as media that will engage sensors 38 and 66, accordion jam detection may be enabled on the first sheet, Block 110. Accordingly, when the media passes through the sensors, it is determined whether the media actually meets the width of the sensors, by triggering both sensors, at Block 120. If the media meets the width of the sensors, Block 130, then the print job will continue to run until the print job has completed, as long as the sensors are triggered. If the media does not meet the width of the sensors then an accordion jam error may be detected at Block 135 and the printer will stop the passage of the media (Block 140) so that the media may be retrieved. If the media is not actually a standard width then the media will trigger a false paper jam, Block 150. After a paper jam, either actual or false, the tray may then be reset or the power may be switched off at Block 10 so that a print job may be reinitiated.

If non-standard width media is sensed after a print job has been initiated, at Block 200, then the accordion jam function may be disabled for the first sheet at Block 210. After the first sheet is fed, it may be determined whether the sheet is narrow media (Block 220), that is media that is not as wide as the sensors or media that triggers less than all of the active sensors. If the media is narrow media then the accordion jam detection may be disabled at Block 225. If it is determined that the media is standard width or wide media, that is media triggering the sensors, at Block 230, then the accordion jam detection may be enabled at Block 235. When accordion jam detection is enabled, a process that is similar to the process in blocks 120-150 may occur.

As tray sensing may be set on by default, tray sensing may also be turned off, as illustrated in Block 300, for a selected print job. When tray sensing is turned off, e.g. the printer is set to feed a non-standard media width, Block 310, the accordion jam detection may be disabled, Block 320.

It is also possible to otherwise manually configure the printer, illustrated in Block 400, to completely disable accordion jam detection, Block 410, or to disable accordion jam detection for only the first sheet, Block 420, regardless of whether standard or non-standard width media is sensed or set. This may be the case when the printer is configured through engine settings or by other means. When the accordion jam detection is disabled for the first sheet, the printer may again determine whether the first sheet is narrow media, that is, media that is too narrow to trigger more than one sensor, Block 430, or media that triggers more than one sensor, Block 440. If the sheet is determined to be narrow media, then the accordion jam detection sensor will be turned off, Block 435. If the media is capable of triggering more than one sensor, then accordion jam detection may again be enabled, Block 445. Accordion jam detection may then follow a process similar to the process illustrated in Blocks 120-150.

Furthermore, it should be appreciated that standard width media may be media such as LGL, LTR, A4, etc. and that non-standard width media may be media such as Universal or A5 media. Regardless, whether the media is sensed as narrow or standard width may be defined by the distance between the sensors across the width or the length of the page. This sensor width may be adjusted to accommodate various sizes of media, including larger (such as size “E” media), smaller or custom sizes.

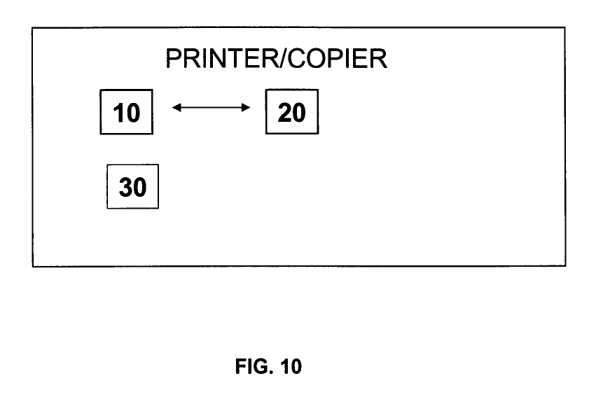

It should also be appreciated that the functionality described herein for the embodiments of the present invention may be implemented by using hardware, software, or a combination of hardware and software, either within the printer or copier or outside the printer copier, as desired. If implemented by software, a processor and a machine readable medium are required. The processor may be of any type of processor capable of providing the speed and functionality required by the embodiments of the invention. Machine-readable memory includes any media capable of storing instructions adapted to be executed by a processor. Some examples of such memory include, but are not limited to, read-only memory (ROM), random-access memory (RAM), programmable ROM (PROM), erasable programmable ROM (EPROM), electronically erasable programmable ROM (EEPROM), dynamic RAM (DRAM), magnetic disk (e.g., floppy disk and hard drive), optical disk (e.g. CD-ROM), and any other device that can store digital information. The instructions may be stored on medium in either a compressed and/or encrypted format. Accordingly, in the broad context of the present invention, and with attention to FIG. 10, the printer or copier may contain a processor (10) and machine readable media (20) and user interface (30). It should be appreciated that the user interface may be any interface that the user has with the electrophotographic device, or any device that may be in communication with the electrophotographic device in which the user may input into the electrophotographic device. Devices in communication with the electrophotographic device may include, but are not limited to, computers, cameras, storage media, scanners, or other devices.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the invention and its practical application to thereby enable one of ordinary skill in the art to best utilize the invention in various embodiments and with various modifications as are suited to the particular use contemplated. It is intended that the scope of the invention be defined by the claims appended hereto.

What is claimed is:

1. A printer comprising:
a media fixing mechanism for fixing images on sheets of media;
a media position sensor capable of identifying and signaling whether media is exiting or not exiting said media fixing mechanism at different locations;
a controller capable of adjusting the feeding of said media through said media fixing mechanism wherein said controller is in communication with said sensor.

2. The printer of claim 1 wherein said controller in communication with said sensor is capable of identifying a time interval between signals received from said sensors.

3. The printer of claim 1 wherein said controller in communication with said sensor is capable of identifying a position interval between signals received from said sensors.

4. The printer of claim 1 wherein said media fixing mechanism comprises a fuser including a fuser roller or belt fuser each having a width and said sensor comprises two sensors positioned at different locations along said width.

5. The printer of claim 1 wherein said sensor comprises two sensors positioned the same distance from said media fixing mechanism.

6. The printer of claim 1 wherein said sensor comprises two sensors positioned at different distances from said media fixing mechanism.

7. The printer of claim 1, wherein said controller which adjusts the feeding of media is capable of stopping the feeding of media through said media fixing mechanism and signaling a user interface.

8. The printer of claim 1 wherein said printer includes a sensor that is capable of detecting a media size dimension and enabling or disabling said controller's capability to adjust said feeding of media.

9. A method of detecting a media jam in a media fixing mechanism for fixing images on sheets of media comprising:
supplying a printer that is capable of feeding media to a media fixing mechanism and wherein said media is capable of exiting said media fixing mechanism;
identifying whether fed media is exiting or not exiting said media fixing mechanism at different locations; and
adjusting the feeding of media to said media fixing mechanism when one portion of media is exiting said media fixing mechanism at one location and one portion is not exiting said media fixing mechanism at another location.

10. The method of claim 9 wherein said step of identifying one portion of media that is exiting said media fixing mechanism comprises identifying a leading edge of said media.

11. The method of claim 9 wherein said adjusting said feeding of media comprises stopping said feeding and signaling a user interface.

12. A method of detecting a media jam in a media fixing mechanism for fixing images on sheets of media comprising:
supplying a printer that is capable of feeding media to a media fixing mechanism and wherein said media is capable of exiting said media fixing mechanism;
sensing a media size dimension;
identifying whether fed media is exiting or not exiting said media fixing mechanism at different locations; and either:
(a) adjusting the feeding of media to said media fixing mechanism when one portion of media is exiting said media fixing mechanism at one location and one portion is not exiting said media fixing mechanism at another location or
(b) feeding said media and not adjusting as in (a).

13. A printer comprising:
a fuser assembly comprising a heated component and a transport component forming a nip having an entry region and exit region for conveying media;
one or a plurality of detack components located adjacent said exit region of the nip;
a sensor disposed adjacent the exit region of said nip capable of identifying and signaling whether media is exiting or not exiting said exit region;
a controller capable of feeding said media through said nip wherein said controller is in communication with said plurality of sensors wherein said controller is capable of adjusting the feeding of media to said media fixing mechanism.

14. The printer of claim 13 wherein said nip has a width and said sensor comprises two sensors positioned at different location along said width.

15. The printer of claim 13 wherein said sensors are positioned at two different distances from said nip.

16. The printer of claim 13 wherein said sensors are positioned at the same distance from said nip.

17. The printer of claim 13 wherein said controller in communication with said sensor is capable of identifying a time interval between signals received from said sensors.

18. The printer of claim 13 wherein said controller in communication with said sensor is capable of identifying a position interval between signals received from said sensors.

19. An article for use in feeding media to a media fixing mechanism comprising:
a storage medium having stored thereon instructions that when executed by a machine result in the following:
sensing a media size dimension;
identifying whether fed media is exiting or not exiting said media fixing mechanism at different locations; and either:
(a) adjusting the feeding of media to said media fixing mechanism when one portion of media is exiting said media fixing mechanism at one location and one portion is not exiting said media fixing mechanism at another location or
(b) feeding said media and not adjusting as in (a).
